(19) United States
(12) Patent Application Publication
(10) Pub. No.: US 2016/0174087 A1
(43) Pub. Date: Jun. 16, 2016

(54) METHOD AND APPARATUS FOR CELL IDENTIFICATION FOR FURTHER ENHANCED NON-CA BASED ICIC FOR LTE

(71) Applicant: ZTE (USA) INC., Austin, TX (US)

(72) Inventor: Carolyn TAYLOR, Homewood (IL)

(21) Appl. No.: 14/908,221

(22) PCT Filed: Jul. 30, 2014
(86) PCT No.: PCT/US2014/048793

§ 371 Date: Jan. 28, 2016

Related U.S. Application Data
(60) Provisional application No. 61/859,876, filed on Jul. 30, 2013.

(51) Int. Cl. H04W 24/08; H04W 48/20; H04B 17/24; H04W 24/10; H04B 17/345

(52) U.S. Cl. CPC H04W 24/08; H04W 24/10; H04B 17/345; H04B 17/24; H04W 48/20

(57) ABSTRACT

A method and apparatus is disclosed to support an instantaneous traffic load situation by selecting the most appropriate cell for user equipment (UE) by means of connecting a UE to a cell that has a reduced transmitting power so a UE can connect to a weaker cell. Inter-cell interference coordination (ICIC) is a multi-cell Radio Resource Management (RRM) function that has the task of managing radio resources such that inter-cell interference is kept under control. A measurement is periodically taken to evaluate the traffic load situation. The resources are reallocated by taking into account information about the resource usage status and traffic load situation. The transmitted power of a stronger cell with a high traffic load is reduced and resources reallocated so a UE can receive data or perform measurement on a weaker cell. Certain embodiments of the invention deal with different measurement/reporting in the presence of interferers.

### FIELD OF THE INVENTION

The present invention relates to a method for coordination based on dynamic use of resources to support instantaneous traffic load situation by selecting the most appropriate cell for a UE by means of connecting a UE to a cell that has reduction of transmitting power so a UE can connect to a weaker cell. It deals with measurement/reporting in the presence of dominant interferers. Specifically, the invention relates to a method for processing measurement/reporting in presence of dominant interferers for testing ICIC.

The method involves reallocation of resources by taking into account information about the resource usage status and traffic load situation. Inter-cell interference coordination (ICIC) is a multi-cell Radio Resource Management (RRM) function that has the task to manage radio resources such that inter-cell interference is kept under control. A preferred method and a system in a packet switched data transfer system for RRM measurements. A measurement is periodically taken to evaluate the traffic load situation. The resources are reallocated by taking into account information about the resource usage status and traffic load situation. The transmitted power of the stronger cell with a high traffic load is reduced and resources reallocated so the UE can receive data or perform measurement on the weaker cell. The invention deals with different measurement/reporting in the presence of interferers: Extending the coverage of a cell by means of connecting a UE to a cell that is weaker than the strongest detected cell is referred to as cell range extension (CRE) measurement and periodic measurement to track and monitor traffic load performance.

### BACKGROUND OF THE INVENTION

Devices with wireless communications capabilities, such as mobile telephones, handheld devices, devices embedded in laptop computers, Machine-2-Machine devices (M2M), and similar devices, will be referred to herein as User Equipment (UE).

Wireless communications is continuously evolving. There are many advanced technology equipment being introduced that can provide services that were not possible previously. This advanced technology equipment might include, for example, an Enhanced Node B (eNB) rather than a base station or other systems and devices that are more highly evolved than the equivalent equipment in a traditional wireless telecommunications system. Such advanced or next generation equipment may be referred to herein as High Speed Packet Access (HSPA) equipment and long-term evolution (LTE) equipment.

In traditional wireless telecommunications systems, transmission equipment in a base station transmits signals throughout a geographic region and is called a “cell”. For LTE and other advanced equipment, the region in which a UE can gain access to a wireless communications network might be referred to as a different name, for instance called a “hot spot”. The terminology for example “cell” will be used herein to refer to any geographic region in which a UE can gain access to a wireless communications network, regardless of the type of UE and regardless of whether the region is a traditional cell, a region served by LTE equipment such as an eNB, or some other region in which wireless communications services are available. Heterogeneous networks (HetNets) consist of a mix of macrocells, remote radio heads, and low-power nodes such as picocells, femtocells, and relays

Leveraging network topology, increasing the proximity between the access network and the end-users, has the potential to provide the next significant performance leap in wireless networks, improving spatial spectrum reuse and enhancing indoor coverage

A HetNet is a network consisting of infrastructure points with various wireless access technologies, each of them having different capabilities, constraints, and operating functionalities.

Different UEs might use different types of radio access technology (RAT) to access a wireless communications network. Some UEs, which can be referred to as multi-mode UEs, are capable of communicating using more than one RAT. For example, multi-mode UEs may include UEs that can obtain service from at least one mode of UMTS (Universal Mobile Telecommunications System), and one or more different systems such as GSM (Global System for Mobile Communications) bands or other radio systems. As defined herein, multi-mode UEs may be of any various type of multi-mode UE as defined or provided in 3GPP (3rd Generation Partnership Project), Technical Specification Group (TSG) Terminals, Multi-Mode UE Issues, Categories, Principles and Procedures (3G TR 21.910), which is included herein by reference for all purposes. Some examples of RATs or of network technologies that might use different types of RATs include UTRAN (UTMS Terrestrial Radio Access Network), GSM, GSM EDGE Radio Access Network (GERAN), Wireless Fidelity (WiFi), General Packet Radio Service (GPRS), High-Speed Downlink Packet Access (HSDPA), High Speed Packet Access (HSPA), and long-term evolution (LTE). Other RATs or other network technologies based on these RATs may be familiar to one of skill in the art.

Inter-cell interference coordination (ICIC) has the task to manage radio resources such that inter-cell interference is kept under control. ICIC mechanism includes a frequency domain component and time domain component. ICIC is inherently a multi-cell Radio Resource Management (RRM) function that needs to take into account information (e.g. the resource usage status and traffic load situation) from multiple cells. The preferred ICIC method may be different in the uplink and downlink.

The frequency domain ICIC manages radio resource, notably the radio resource blocks, such that multiple cells coordinate use of frequency domain resources.

For the time domain ICIC, subframe utilization across different cells are coordinated in time through backhaul signalling or OAM configuration of so called Almost Blank Subframe patterns. The Almost Blank Subframes (ABSs) in an aggressor cell are used to protect resources in subframes in the victim cell receiving strong inter-cell interference. Almost blank subframes are subframes with reduced transmit power (including no transmission) on some physical channels and/or reduced activity.

The eNB ensures backwards compatibility towards UEs by transmitting necessary control channels and physical signals as well as System Information.

Patterns based on ABSs are signalled to the UE to restrict the UE measurement to specific subframes, called measurement resource restrictions. There are different patterns depending on the type of measured cell (serving or neighbour cell) and measurement type (e.g. RRM, RLM).

MBSFN subframes can be used for time domain ICIC when they are also included in ABS patterns. The eNB cannot configure MBSFN subframes TS 36.211 [4] as ABSs when these MBSFN subframes are used for other usages (e.g., MBMS, LCS).

Extending the coverage of a cell by means of connecting a UE to cell that is weaker than the strongest detected cell is referred to as cell range extension (CRE). With time domain ICIC, a CRE UE may continue to be served by a victim cell (i.e. the weaker cell) even while under strong interference from aggressor cells (i.e. the stronger cell).

A UE under strong interference from aggressor cells may need to mitigate interference from the aggressor cells on some physical channels and signals in order to receive data from serving cell or to detect the weak cells or to perform measurements on the weak cells.

The network may provide SIB1 to the UE in the CRE region by a dedicated RRC signaling to assist UE system information acquisition. ICIC is located in the eNB.

For the UE to measure “protected” resources of the serving cell and/or neighbour cells, RRM/RLM/CSI measurement resource restriction is signalled to the UE. There are three kinds of measurement resource restriction patterns that may be configured for the UE.

Pattern 1: A single RRM/RLM measurement resource restriction for the Primary Cell (PCell).

Pattern 2: A single RRM measurement resource restriction for indicated list of neighbour cells operating in the same carrier frequency as the PCell.

Pattern 3: Resource restriction for CSI measurement of the PCell. If configured, two subframe subsets are configured per UE. The UE reports CSI for each configured subframe subset.

In RRC_CONNECTED, the RRM/RLM/CSI measurement resource restrictions are configured by dedicated RRC signalling.

The network may configure the UE with CRS assistance information of the aggressor cells in order to aid the UE to mitigate the interference from CRS of the aggressor cells.

The Rel-10 work item on “Enhanced inter-cell interference coordination (ICIC) for non-Carrier Aggregation based deployments of heterogeneous networks (HetNet) for LTE” provides signalling and performance requirements in relation to the support of co-channel deployments of heterogeneous networks. Due to time limitations, some identified techniques to enhance ICIC were de-prioritized for Rel-10. With growing demand for data services, it is becoming rather difficult to meet the required data capacity and cell edge spectrum efficiency through simple cell splitting and current ICIC mechanisms.

Further Enhanced Non-CA Based ICIC for LTE is needed for an efficient support of heterogeneous networks for Rel-11. There was an agreement on time division multiplexing (TDM) resource partitioning that can offer performance benefits and the impact of legacy transmissions in almost blank subframes on control/data channels demodulation needs to be addressed. UE performance requirements and necessary signalling to the UE for significantly improved DL control and data detection and UE measurement/reporting in the presence of dominant interferers (including colliding and non-colliding RS, as well as, MBSFN used as ABS, as well as, ABS subframe configurations) for FDD and TDD systems depending on UE receiver implementations is needed. Improved detection based on air interface enhancements need to also be considered.

### BRIEF SUMMARY OF THE INVENTION

An object of the invention is to provide a method for processing measurement/reporting in presence of dominant interferers for testing ICIC as discussed above.

Hence, in a first aspect there is provided a multi-mode UE. The multi-mode UE includes a processor configured to promote measurements of a signal strength in a communication system running an application that increasingly demand higher data rates.

In the second aspect the multi-mode UE includes a processor configured to promote measurements of a signal strength from a network component to the multi-mode UE.

In the third aspects transmissions can occur either during the downlink control channel region or data region, or when both are going to receive strong interference.

In the fourth aspect provides measurement capabilities for the multi-mode UE and network in order to facilitate cell range extension (CRE) measurements and periodic measurements. The method includes measuring the coverage of a cell by means of connecting a multi-mode UE to a cell that is weaker than the strongest detected cell and periodic measurements to track and monitor traffic load performance.

In the fifth aspect a method that instructs a multi-mode UE from a serving cell to look for neighbour cells of other networks by scanning all cells.

In the sixth aspect a method for a communication network that includes a eNB and at least one multi-mode UE within the communication range of the serving cell and at least one neighbor cell. The method includes a transmitter configured for sending, a periodic measurement to track and monitor traffic load performance and inform the serving cell of interference capability of at least one multi-mode UE and of measurements of signals received by at least one multi-mode UE from the serving cell and a neighbor cell, where at least one measurement includes a parameter for determining at least one multi-mode UE with respect to the weaker cell; and determining, based on at least one report that includes an indication of, whether to reduce the transmitted power of the stronger cell with a high traffic load and reallocate resources so the multi-mode UE can receive data or perform measurement on the weaker cell.

In the seventh aspect a method for measuring signal strength is provided. The method includes creating a criterion that triggers the multi-mode UE to send a measurement report. This can either be periodical or a single event description.

In the eighth aspect a method that includes a receiver configured for receiving a report to inform the serving cell of an interference capability of the multi-mode UE and of measurements of signals received by the multi-mode UE from the serving cell and a neighbour cell, wherein the report includes a parameter for determining the multi-mode UE with respect to the weaker cell; and determining, based on at least the parameter, extending the coverage of the cell by means of connecting a multi-mode UE to a cell that is weaker than the strongest detected cell.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of a wireless communications system according to an embodiment of the disclosure.

FIG. 2 is a diagram of a data transmission according to an embodiment of the disclosure.

FIG. 3 is a diagram of a method for measuring signal strength according to an embodiment of the disclosure.

FIG. 4 is a diagram of a wireless communications system including a user equipment and serving cell operable for some of the various embodiments of the disclosure.

FIG. 5 is a diagram of a wireless communications system that illustrates how a eNB can use knowledge of interference capabilities and parameters of user equipment.

### DETAILED DESCRIPTION OF THE INVENTION

The present inventions now will be described more fully hereinafter with reference to the accompanying drawings, in which some examples of the embodiments of the inventions are shown. Indeed, these inventions may be embodied in many different forms and should not be construed as limited to the embodiments set forth herein; rather, these embodiments are provided by way of example so that this disclosure will satisfy applicable legal requirements.

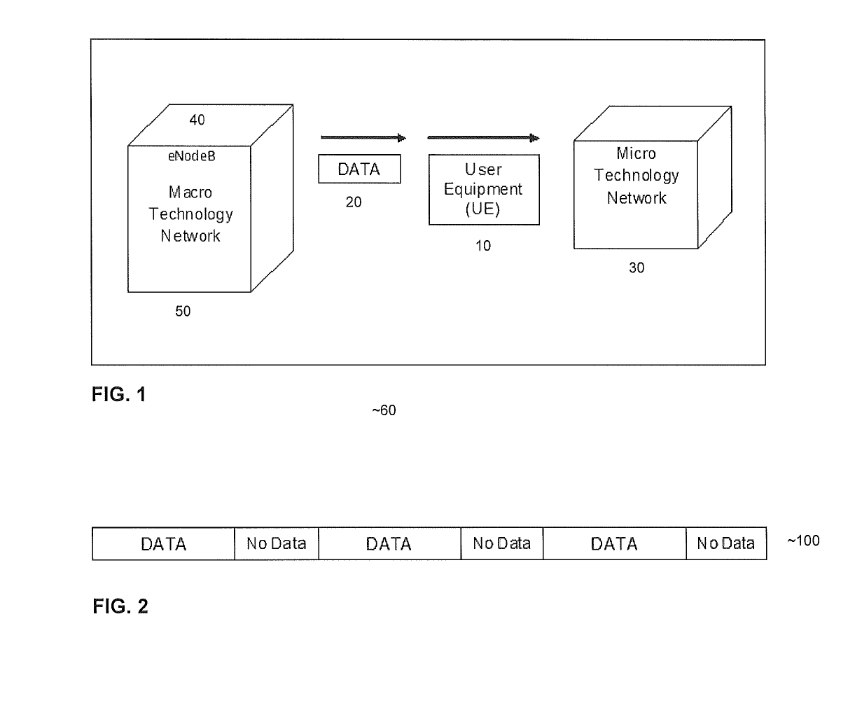

FIG. 1 illustrates a situation in which such a measurement might occur. A UE is moving from a macro technology network toward a micro technology network. The macro technology network includes an eNB, or a similar component. The UE may be engaged in a macro technology running an application via the eNB. That is, the eNB is transmitting data to the UE or is otherwise in communication with the UE.

FIG. 2 illustrates a detailed view of the data transmission from the eNB to the UE. The data transmission consists of a series data strings separated by transmission period in which no data and data is transmitted. The data strings might represent some type of a user-directed data transmission. During the period which no data is transmitted, the UE can measure the strengths of the signals that it receives. In a first technique, a method for measuring signal strength is provided. The method includes reporting multi-mode UE interference capability. The method includes the multi-mode UE being measured. In an alternative of this technique, a method for measuring signal strength is provided. The method includes periodic measurements to track and monitor traffic load performance.

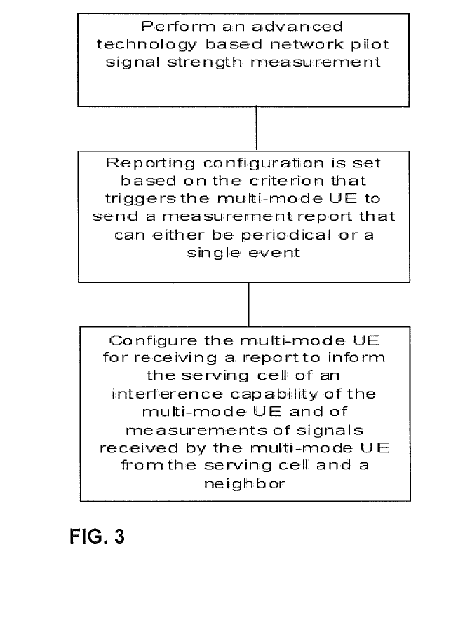

FIG. 3 illustrates an embodiment of a method for measuring the strength of the multi-mode UE of UE interference capability. The UE send a measurement reporting.

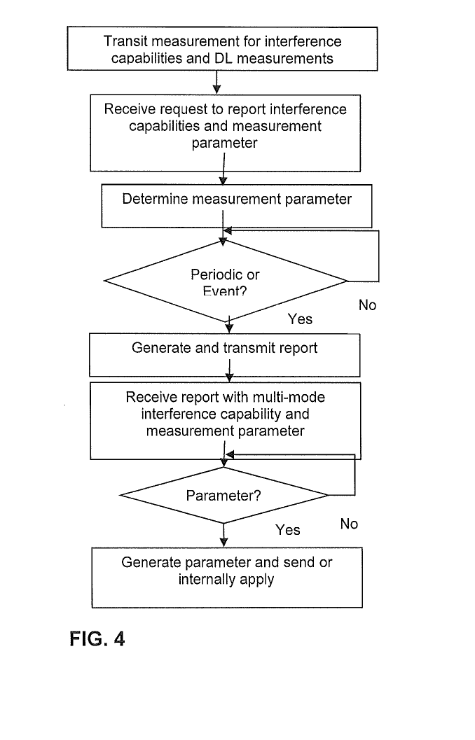

FIG. 4 is a flowchart that illustrates methods of operating a serving cell and a multi-mode UE for a wireless communications system. The serving cell transmits at least one message to at least one multi-mode UE within its cell that the UEs should inform the cell of the Interference capability of the respective UEs and their DL signal measurements, e.g., the RSRP of the serving cell and RSRPs of candidate neighbor cells, which can be macro cells and/or micro/pico/femto cells. The at least one message includes a parameter value for use by a multi-mode UE in determining its parameter with respect to the candidate neighbor cell, particularly the strongest neighbor cell.

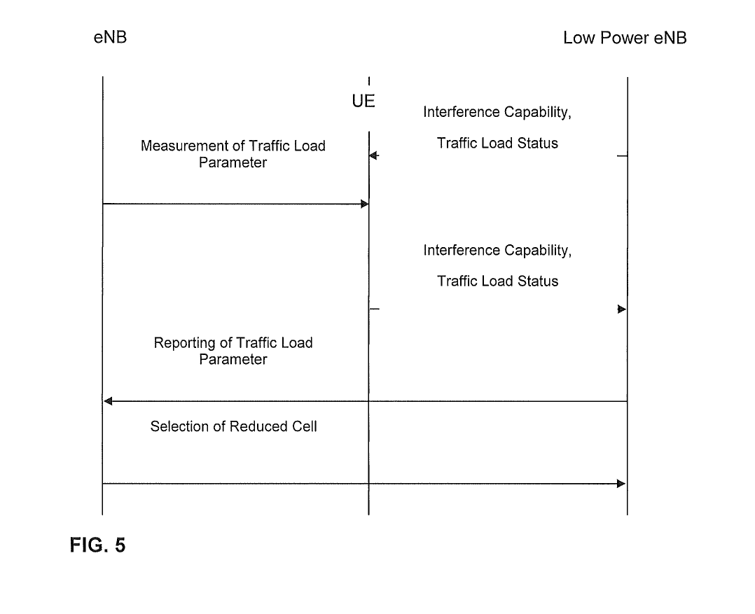

FIG. 5 depicts an example of a wireless communication system that illustrates in more detail how eNB can use knowledge of UEs' Interference capabilities and parameters with respect to weaker cells by reduction of power. The wireless communication system includes a macro cell, underlying weaker cells, which can be micro, pico, or femto cells, and multi-mode UEs. As described above, a serving cell, becomes aware of the existence of a multi-mode UE, and possibly other UEs in an extended coverage area of a neighbor cell and based on reports from the multi-mode UEs that indicate the UEs' respective interference capabilities, the serving cell becomes aware of those respective interference capabilities. Based on that information and other measurements, such as the instantaneous traffic load situations in the serving and neighbor cells it can be determined whether to extend the range of the neighbor cell.

Adaptations of known systems and methods that are apparent to those skilled in the art based on the description of the invention contained herein are within the scope of the claims. Moreover, later-invented or later-developed equipment that carries out the methods and/or combination of elements set forth in the claims are within the scope of the invention. Accordingly, the description is not intended to limit the invention to the form or application disclosed herein.

1.-10. (canceled)

11. A method of measuring interference capability in a multi-mode user equipment (UE), said method comprising:
measuring, by the multi-mode UE, a network signal strength;
sending, by the multi-mode UE, a measurement report based on said measuring; and
receiving, by the multi-mode UE, a report to inform a serving cell of an interference capability of the UE and measurement of signals received by the UE from the serving cell and a neighbor cell.

12. The method of claim 11, wherein the measuring is periodic.

13. The method of claim 11, further comprising setting, by the UE, a reporting configuration based on a condition, wherein the condition triggers the sending.

14. The method of claim 11, wherein the measuring occurs when no data is transmitted.

15. The method of claim 11, wherein the network signal strength is a network pilot signal strength.

16. A method of measuring interference capability in a multi-mode user equipment (UE), said method comprising:
transmitting, by the multi-mode UE, a measurement for interference capabilities;
receiving, by the multi-mode UE, a request to report interference capabilities and a measurement parameter;
determining, by the multi-mode UE, the measurement parameter; and
generating and transmitting, by the multi-mode UE, a report, wherein interference capabilities and the measurement parameter is reported.

17. A multi-mode user equipment (UE) comprising:
a transmitter configured to send a periodic measurement to track and monitor traffic load performance and inform a serving cell of interference capability and of a signal measurement received, by the multi-mode UE, from the serving cell and a neighbor cell; and
wherein the measurement includes a parameter for determining, based on a report, whether to reduce transmitted power of a stronger cell with a high traffic load and reallocate resources so the multi-mode UE can receive data or perform measurement on a weaker cell.

18. The multi-mode UE of claim 17, wherein the transmitter is further configured to send a measurement report when a criterion is triggered.

19. The multi-mode UE of claim 18, wherein the transmitter is further configured to send the measurement report periodically.

20. A method in a communication system comprising:
receiving a report to inform a serving cell of an interference capability of a multi-mode user equipment (UE) and of measurements of signals received by the multi-mode UE from the serving cell and a neighbor cell, wherein the report includes a parameter; and
determining, based on the parameter, whether to connect the multi-mode UE to a cell that is weaker than the strongest detected cell.
